(19) United States
(12) Patent Application Publication
(10) Pub. No.: US 2007/0269573 A1
(43) Pub. Date: Nov. 22, 2007

(54) Device and method for distribution of condiments

(76) Inventors: Carol Boyer, Mooresville, NC (US); Dana Absher, Concord, NC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/435,951

(22) Filed: May 17, 2006

(51) Int. Cl. A23L 1/40

(52) U.S. Cl. 426/589

(57) ABSTRACT

The invention is a device for distributing condiments on a food product. The device includes a compressible and expandable hollow structure and reversible fastening means on one end of the hollow structure for fastening the structure to a vessel.

### BACKGROUND OF THE INVENTION

The invention relates to the field of food product consumption. More particularly, the invention relates to the field of consumption of finger foods.

Many consumers, in today's society, enjoy finger foods, i.e., foods that can be eaten by hand. Such foods are often served in containers, such as bags, tubs, and/or boxes. For example, popcorn at different movie theaters is often served in each of the above vessels.

One difficulty with finger foods in typical vessels is the problem of distributing condiments across the entire food product. As recognized by those having ordinary skill in the art, when a condiment is placed on top of a food product in a vessel, it is difficult, if not impossible, to distribute the condiment to the food in the bottom of the vessel without losing some of the food in the vessel. Similarly, if the condiment is placed in the bottom of the vessel or the middle of the vessel, the same problem exists if trying to distribute the condiment across the entire food product.

As a common example of the problem of distributing condiments, movie goers often find it difficult to evenly distribute butter and/or salt, as well as other seasonings, throughout their popcorn. A movie goer typically purchases a vessel, such as a bag or box, of popcorn at the concession stand before the movie begins. Butter or salt, as well as other seasonings, if desired, may then be added to the popcorn after the bag or box is filled. If the patron desires butter, salt, or seasonings on all of the popcorn, that patron will typically shake the vessel in an attempt to distribute the condiment(s) across all of the popcorn. Those having ordinary skill in the art will recognize that this attempt to distribute the condiments is often unsuccessful. Moreover, this often results in the patron spilling the popcorn that actually is covered with the condiment out of the vessel and/or loss of the product purchased, resulting in the loss of most or all of the condiment without gaining the benefit of distribution of the condiment.

Similar problems may exist when the condiments are added to the bottom of a vessel or to the middle of the vessel. In either case, the vessel must be agitated to distribute the condiments, resulting in spillage.

An attempt to overcome this may include filling the vessel to a point below the top of the vessel.

Spillage may be less likely to occur in this scenario, but the inside of the vessel may be coated with residual condiments. In this scenario, a patron must then reach through the coated portion of the vessel to reach the food product, typically resulting in transfer of the condiment to the patron's hand, arm, and/or shirt sleeve. Thus, though spillage is reduced, another problem exists.

Another typical attempt to solve the problem of poor condiment distribution includes filling the vessel to a point below the top of the vessel and agitating the vessel, then tearing the top of the vessel off. This often results in uneven tearing, thereby causing more spillage and poor condiment distribution.

In yet another typical attempt to improve condiment distribution, a patron may place an additional, inverted vessel over the vessel containing the food product and condiment, then agitate the vessels and the food product contained therein, to distribute the condiment. While this may improve condiment distribution, additional vessels are often unavailable for this purpose, rendering the solution unobtainable. Where the additional vessels are available, they are typically offered at additional cost and are incompatible for the present purpose.

### SUMMARY OF THE INVENTION

In one aspect the invention is a device for enabling the even distribution of condiments on a food product. The device includes a vessel having at least a first closed end and having a removably attached portion secured to a second end of the vessel via fastening means.

In another aspect, the invention is a device for distributing condiments on a food product. The device includes a compressible and expandable hollow structure and reversible fastening means on one end of the hollow structure for fastening the structure to a vessel.

In yet another aspect, the invention is a method of distributing condiments on a food product. The method includes filling a vessel, having a removably attached portion at or near the top of the vessel, with a food product to a point at or below a bottom edge of the removably attached portion, such that the volume of the vessel between a top edge of the removably attached portion and the bottom edge of the removably attached portion is substantially free of food product. The method further includes adding at least one condiment to the vessel and agitating the food product into the removably attached portion and back into the body of the vessel to evenly distribute the condiment across the food product.

The foregoing, as well as other objectives and advantages of the invention and the manner in which the same are accomplished, is further discussed within the following detailed description and its accompanying drawings.

### BRIEF DESCRIPTION OF THE DRAWING

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements.

FIG. 1 is a schematic representation of one embodiment of a device in a separated configuration according to the present invention.

FIG. 2 is a schematic representation of the device of FIG. 1 in an attached configuration according to the present invention.

FIG. 3 is a schematic representation of yet another embodiment of a device according to the present invention.

### DETAILED DESCRIPTION

The invention relates to a device and method for evenly distributing condiments across a food product.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

For ease of discussion, the method and apparatus may be described with specific reference to the distribution of salt and/or butter over popcorn. Those having ordinary skill in the art will recognize that the invention is applicable to distribution of a variety of condiments over a variety of food products, and shall not be so limited. Similarly, the method and apparatus will be described with respect to distribution of condiments over food products. Those having ordinary skill in the art will recognize that the invention is applicable to distribution of one food product within another food product (i.e., evenly mixing two types of candy), and shall not be so limited.

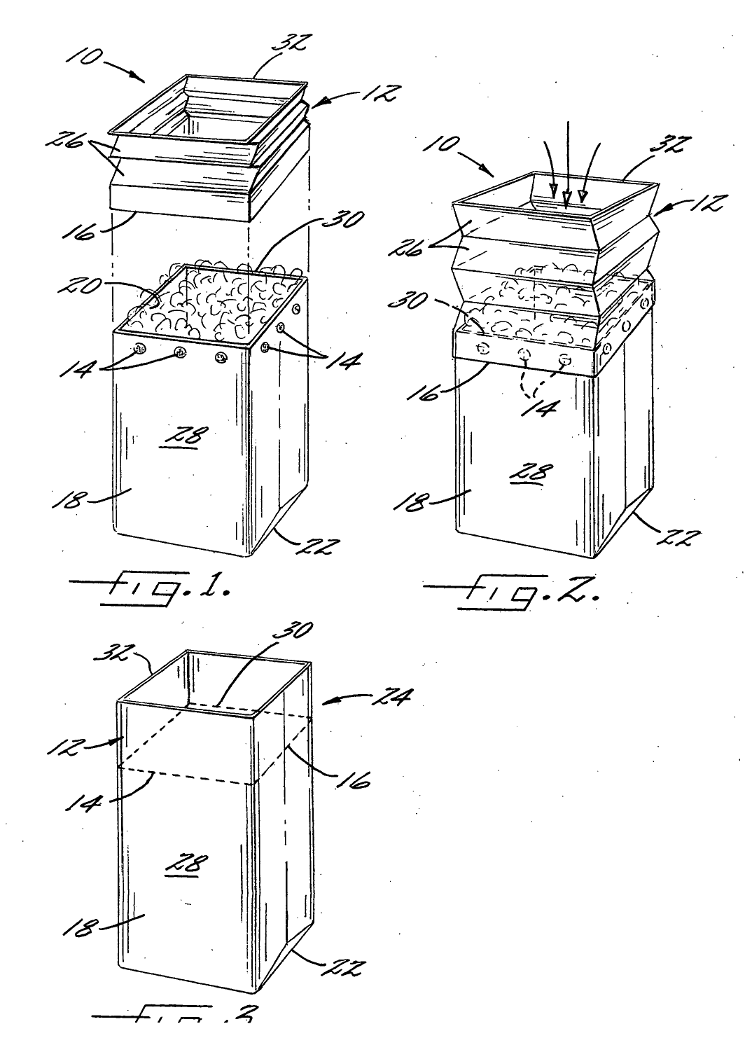

In one aspect, with reference to FIG. 1, the invention is a device 10 for distributing condiments on a food product. The device 10 includes a compressible and expandable hollow structure 12 and reversible fastening means 14 for fastening the structure 12 to a vessel 18. The fastening means 14 may be located on the vessel 18 (as shown), on the hollow structure 12, or both.

In one embodiment, the compressible and hollow structure 12 and the vessel 18 are formed of materials independently selected from one or more of paper, plastic, paperboard, cardboard, insulated paper, wax paper, foil, combinations thereof, and the like. Those having ordinary skill in the art may recognize other suitable materials for formation of the hollow structure 12 and vessel 18. Those other materials, recognizable by those having ordinary skill in the art, are contemplated as useful in the present invention. The specification and claims shall, therefore, be read and understood to include such variations.

In some embodiments, it may be desirable to include a non-stick coating on an interior surface of the hollow structure 12 to prevent residual condiment from adhering to the sides of the hollow structure and to ensure maximum condiment distribution across the food product. Similarly, it may be desirable to include a non-stick coating on an interior surface of the vessel.

In exemplary embodiments, the vessel 18 may be a bag, a box, a tub, and the like. Those having ordinary skill in the art may recognize additional vessels that may be suitable for use in accordance with the present invention. The specification and claims should be read and understood to include additional vessels recognizable to those having ordinary skill in the art.

Exemplary vessels 18 in accordance with the present invention include one closed end 22 and one open end 20. In an exemplary embodiment, the open end 20 is opposite the closed end 22 of the vessel. Those having ordinary skill in the art will recognize that the closed end 22 may be openable and closeable, so long as it is closed in at least one configuration. In a non-limiting example, the closed end 22 may be configured similarly to the end of a typical cereal box known in the art.

Similarly, the open end 20 may have at least one configuration that is closed, so long as it may be opened when attached to the present hollow structure 12.

The compressible and expandable hollow structure 12 may be at least about ¼ the height of the vessel 18 when the structure 12 is fully extended. In some embodiments, the structure 12 may be between about ¼ the height of the vessel 18 and equal to the height of the vessel 18 when fully extended. In other embodiments, the structure 12 may have a fully extended height greater than the height of the vessel 18.

Those having ordinary skill in the art will recognize the height of the hollow structure 12, when extended, may vary depending upon the size of the vessel 18. Moreover, the height of the hollow structure 12, when extended, may also be dependent on the food product or condiment to be distributed throughout the food product. Stated differently, the height of the hollow structure 12, when extended, shall not be limited to the dimensions described above, but shall be determined by those having ordinary skill in the art based on the size of the vessel 18 and the height necessary to fully agitate the contents of the vessel.

In one embodiment, the fastening means 14 may be permanently or removably attached to one or more of the hollow structure 12 and the vessel 18. Suitable fastening means 14 contemplated as useful in the present invention include one or more of an adhesive strip, fastening tabs, intermittent adhesive regions, perforated attachment to a vessel, hook and loop fastenings (i.e., VELCRO®), other fastening means known in the art, combinations thereof, and the like. The fastening means 14 may provide continuous fastening between the vessel 18 and the hollow structure 12 or may provide intermittent fastening between the vessel 18 and the hollow structure 12. Those having ordinary skill in the art may recognize other suitable fastening means 14 in accordance with the present invention. The specification and claims should be read to include other fastening means 14 recognizable by those having ordinary skill in the art.

The hollow structure 12 may further include stabilizers, such as cardboard tabs, for maintaining the hollow structure 12 in its expanded state.

In an exemplary embodiment, the hollow structure 12 may define a cross-section having a geometrical shape selected from round, square, rectangular, oval, polygonal, trapezoidal, other shapes known in the art, and the like. Similarly, the vessel 18 may define a cross-section having a geometrical shape selected from round, square, rectangular, oval, polygonal, trapezoidal, other shapes known in the art, and the like.

Those having ordinary skill in the art will recognize that in some embodiments it may be desirable for the hollow structure 12 and the vessel 18 to have similar geometrical cross-sections. Nevertheless, the geometrical cross-sections of the hollow structure 12 and the vessel 18 may be independently selected.

In one embodiment, as depicted in FIG. 2, the bottom edge 16 of the hollow structure 12 may be removably fastened, via the fastening means 14, to an open end 20 of the vessel 18. In yet another embodiment, the bottom edge 16 of the hollow structure 12 may be permanently fastened, as depicted in FIG. 3, via the fastening means 14, to an open end 20 of the vessel 18.

In embodiments where the hollow structure 12 is removably fastened to the vessel 18, it may be desirable for the bottom edge 16 of the hollow structure 12 to overlap the top end 30 of the vessel 18 to reduce leakage of the condiment between the vessel 18 and the hollow structure 12. The overlap may be between about ½ inch and 3 inches. The height of the overlap may be controlled by the location of the fastening means 14 on one or both of the hollow structure 12 and the vessel 18.

In another aspect, and with reference to FIG. 3, the invention is a device 24 including a vessel 18 having at least a first closed end 22 and having a removably attached portion 12 secured to a second, open end 20 of the vessel 18 via fastening means 14. In an exemplary embodiment, the open end 20 of the vessel 18 is opposite the closed end 22 of the vessel 18. Those having ordinary skill in the art will recognize that the closed end 22 may be permanently closed or may be openable and recloseable.

In one embodiment, the removably attached portion 12 of the vessel 18 is expandable and compressible. Stated differently, the removably attached portion 12 may be expanded and compressed vertically with respect to the vessel 18. The removably attached portion 12 may expand via accordion folds 26. The removably attached portion 12 may also be folded over an outside surface 28 of the vessel 18. Other methods of expanding and compressing the removably attached portion 12 are also contemplated as useful in accordance with the present invention.

In some embodiments, the removably attached portion 12 may be reusable and reattachable. For example, the removably attached portion 12 may be attached to different vessels 18 and used more than one time for condiment distribution. In alternate embodiments, such as the embodiment depicted in FIG. 3, the removably attached portion 12 is disposable and is used with a single vessel 18.

In another aspect, the invention is a method of distributing condiments on a food product. The method includes filling a vessel 18, having a removably attached portion 12 at or near the top 30 of the vessel 18, with a food product to a point at or below a bottom edge 16 of the removably attached portion 12, such that the volume between a top edge 32 of the removably attached portion 12 and the bottom edge 16 of the removably attached portion 12 is substantially free of food product. The method further includes adding at least one condiment to the vessel 18 and agitating the food product into the removably attached portion 12 and back into the body of the vessel 18 to evenly distribute the condiment across the food product.

In one embodiment, the method may further include extending the removably attached portion 12 of the vessel 18 prior to the step of agitating the food product to provide more room for the agitation to occur.

Those having ordinary skill in the art will recognize that the steps of the method may be conducted in varying orders. For example, the step of adding at least one condiment may be conducted before the step of adding the food product. Similarly, the step of extending the removably attached portion 12 may be conducted before the addition of either or both of the food product and the condiment. In another example, the removably attached portion may be attached to the vessel 18 after addition of the food product and/or condiment. The specification and claims shall be read and understood to include the varying orders in which the method steps may be conducted.

The method may further include the step of separating the removably attached portion 12 from the vessel 18 after the agitation step. In an exemplary embodiment, the fastening means 14, discussed above, may be released to separate the removably attached portion 12 from the vessel 18. The separation step may better enable a person to enjoy the food product without encountering any condiment residue remaining in the removably attached portion 12 after the agitation step. Moreover, the separation step may enable reuse of the removably attached portion 12 on a different vessel.

The separation step may be conducted by releasing the fastening means. For example, if the fastening means is a perforated strip, the separation step may be conducted by tearing along the perforation. If the fastening means is an adhesive strip, the separation step may be conducted by breaking the adhesive bond. Those having ordinary skill in the art will recognize other methods of conducting the separation step in accordance with the present invention. The specification and claims shall be read and understood to include these alternate separation means.

In another embodiment, the method may include compressing the removably attached portion, in addition to or alternatively to separating the removably attached portion from the vessel, after the agitation step. The compression step may be conducted along accordion style folds 26 in the removably attached portion or by folding the removably attached portion. The compression step may be desirable where the user desires to conduct an additional agitation step while consuming a food product.

As a non-limiting example, if salt were distributed according to the present invention, it may further migrate to the bottom of the vessel during consumption of the food product, resulting in unsalted food near the middle of the vessel. In this situation, a user may desire an additional agitation step to redistribute the salt. In such a situation, it may be desirable to compress the removably attached portion 12 and reexpand the removably attached portion 12 as necessary to conduct at least one additional agitation step.

The present invention provides a device and method for enabling the distribution of condiments throughout a food product. Suitable food products contemplated as useful in accordance with the present invention are finger foods selected from one or more of popcorn, French fries, onion rings, chips, bite-sized fried foods (e.g., chicken, shrimp), pretzels, combinations thereof, and the like.

Suitable condiments suitable for distribution in accordance with the present invention may be selected from one or more of salt, seasonings, mustard, dressings, butter, margarine, butter topping, ketchup, cheese, pepper, hot sauce, bread crumbs, mayonnaise, combinations thereof, and the like.

Similarly, the present invention may be suitable for mixing two or more different food products to provide an even distribution of the food products. For example, two or more candies or trail mixes may be distributed. In another example, chocolate candies and popcorn may be evenly distributed in small serving sizes.

The present device and apparatus enables the distribution of condiments or other food products without loss of the food product during the distribution through the inclusion of the removably attached portion as described above. The removably attached portion of the present device additionally enables enjoyment of the food product without the worry of residual condiments staining shirt sleeves due to the removable aspect of the invention. Accordingly, the present invention overcomes the currently existing drawbacks to the enjoyment of various finger foods.

The present device may be manufactured such that the hollow structure 12 and the vessel 18 are separate at the time of manufacture and must be assembled by the end user (or merchant) prior to use as depicted in FIGS. 1 and 2. In another embodiment, the present device may be manufactured such that the hollow structure 12 and the vessel 18 are attached at the time of manufacture and may be used without further assembly (other than the optional step of extending the hollow structure 12) as depicted in FIG. 3.

Where the hollow structure 12 is manufactured separately from the vessel 18, it may be provided to end users, such as merchants or consumers, independently of the vessel 18. In such a case, the end user may purchase the vessel 18 of their choosing and adapt the hollow structure 12 to fit the vessel 18. A controlling factor in this embodiment is that the hollow structure 12 should have a diameter substantially the same as or greater than the diameter of the top of the vessel 18. Hollow structures 12 including fastening means such as adhesive strips or intermittent adhesive locations as previously described may be more useful in the present embodiment. The present embodiment is not, however, limited to adhesive fastening means.

In the specification, drawings, and examples, there have been disclosed typical embodiments of the invention and, although specific terms have been employed, they have been used in a generic and descriptive sense only and not for purposes of limitation, the scope of the invention being set forth in the following claims.

1. A method of distributing condiments on a food product, the method comprising:
filling a vessel, having a removably attached portion at or near the top of the vessel, with a food product to a point at or below a bottom edge of the removably attached portion, such that the volume of the vessel between a top edge of the removably attached portion and the bottom edge of the removably attached portion is substantially free of food product;
adding at least one condiment to the vessel; and
agitating the food product into the removably attached portion and back into the body of the vessel to evenly distribute the condiment across the food product.

2. A method of distributing condiments further comprising the step of extending the removably attached portion of the vessel prior to the step of agitating the food product.

3. A method of distributing condiments according to claim 2, wherein the step of extending the removably attached portion of the vessel is conducted before the step of filling the vessel.

4. A method of distributing condiments according to claim 2, wherein the step of adding the desired condiments is conducted before the step of extending the expandable portion of the vessel.

5. A method of distributing condiments according to claim 1, wherein the step of adding the desired condiments to the vessel is conducted before the step of filling the vessel.

6. A method of distributing condiments according to claim 2, further comprising the step of separating the removably attached portion of the vessel from the vessel after the agitation step.

7. A method of distributing condiments according to claim 6, wherein the step of separating the removably attached portion of the vessel comprises tearing the removably attached portion along a perforated strip.

8. A method of distributing condiments according to claim 6, wherein the step of separating the removably attached portion of the vessel comprises releasing a fastening device to separate the removably attached portion of the vessel from the vessel.

9. A method of distributing condiments according to claim 1, further comprising the step of compressing the removably attached portion of the vessel after the agitation step.

10. A method of distributing condiments according to claim 1, wherein the step of filling the vessel comprises filling the vessel with finger foods selected from one or more of popcorn, French fries, onion rings, chips, bite-sized fried foods, and pretzels.

11. A method of distributing condiments according to claim 1, wherein the step of adding condiments to the vessel comprises adding one or more of salt, seasonings, mustard, dressings, butter, margarine, butter topping, ketchup, cheese, pepper, hot sauce, bread crumbs, and mayonnaise.

12. A device for enabling the even distribution of condiments on a food product, the device including a vessel having at least a first closed end and having a removably attached portion secured to a second end of the vessel via fastening means.

13. A device according to claim 12, wherein said second end of said vessel is opposite said first closed end.

14. A device according to claim 12, wherein said removably attached portion is expandable.

15. A device according to claim 12, wherein said vessel may be one or more of bag, a box, and a tub.

16. A device according to claim 12, wherein said vessel may be formed from one or more of paper, cardboard, insulated paper, plastic, paperboard, wax paper, and foil.

17. A device according to claim 12, wherein said vessel may have a shape selected from one or more of round, square, oval, rectangular, polygonal, cylindrical, and trapezoidal.

18. A device according to claim 12, wherein said fastening means may be one or more of an adhesive strip, a perforated strip, fastening tabs, intermittent adhesive regions, and hook and loop fastenings.

19. A device according to claim 12, wherein said removably attached portion is folded over the outside edge of the box.

20. A device according to claim 12, wherein said removably attached portion is compressed in an accordion fashion.

21. A device according to claim 12, wherein said removably attached portion is reusable.

22. A device for distributing condiments on a food product, the device comprising:
a compressible and expandable hollow structure; and
reversible fastening means on one end of said hollow structure for fastening said structure to a vessel.

23. A device according to claim 22, wherein said compressible and expandable hollow structure comprises one or more of paper, plastic, paperboard, cardboard, insulated paper, wax paper, and foil.

24. A device according to claim 22, wherein said fastening means comprises one or more of an adhesive strip, fastening tabs, intermittent adhesive regions, perforated attachment to a vessel, and hook and loop fastenings.

25. A device according to claim 22, wherein said hollow structure defines a diameter having a shape selected from the group consisting of round, square, rectangular, oval, polygonal, and trapezoidal.

26. A device according to claim 22, wherein said structure is configured to be fastened to an open end of a vessel selected from one or more of bags, boxes, and tubs.

27. A device according to claim 22, wherein said fastening means is permanently attached to said structure.

28. A device according to claim 22, wherein said fastening means is removably attached to said structure.
